(19) United States
(12) Patent Application Publication
(10) Pub. No.: US 2012/0318878 A1
(43) Pub. Date: Dec. 20, 2012

(54) Controlling Smoke and Heat Evacuation and Ventilation Devices

(75) Inventor: Brian Park, Newcastle-upon-Tyne (GB)

(73) Assignee: CUSTOM ELECTRONICS LIMITED, Tyne and Wear (GB)

(21) Appl. No.: 13/525,437

(22) Filed: Jun. 18, 2012

(30) Foreign Application Priority Data
Jun. 18, 2011 (GB) 1110410.6

(51) Int. Cl. F24F 11/00; A62C 99/00

(52) U.S. Cl. 236/49.2; 236/49.3; 169/61; 169/43

(57) ABSTRACT

The controlling of a plurality of smoke and heat evacuation and ventilation (SHEV) devices is shown, in which the devices are connected to field wiring that also includes fire detection devices and alarms. A constant limited current (705) is supplied in a first direction for fire detection. A non-limited voltage is applied to supply alarm current 708 in a second direction for sounding alarms and opening the SHEV DEVICES. A non-limited positive voltage 712 is applied to supply reset current in the first direction for closing the SHEV devices.

### CROSS REFERENCE TO RELATED APPLICATIONS

This application represents the first application for a patent directed towards the invention and the subject matter.

### BACKGROUND OF THE INVENTION

1. Field of the Invention

The present invention relates to the control of smoke and heat evacuation and ventilation (SHEV) devices. The present invention also relates to SHEV control apparatus that is compatible with fire alarm systems.

2. Description of the Related Art

In many regions around the world, regulations are being put in place for the introduction of smoke and heat evacuation and ventilation devices into buildings. In particular, these regulations often relate to relatively large buildings and buildings that may be described as being of multiple occupancy. Thus, in many applications, it is necessary to include smoke and heat evacuation and ventilation apparatus in order to provide more time for residents to be evacuated when a fire has been detected.

In buildings of multiple occupancy, smoke may be vented naturally by opening windows and for a specified room volume, it is possible to calculate the size of window that is required. Windows of this type are usually positioned just below ceiling height, given that this is where the combustible gases collect. Thus, upon fire detection, the system is configured to exhaust this gas as quickly as possible from regions close to the ceiling. Windows can be louvered or opened from a hinge on their bottoms edge. The removal of smoke allows residents to escape and facilitates fire extinguishing activities.

Regulations are being developed in which all of the wires must be monitored and the detection circuits must also be monitored. While solutions are available, problems exist in that a substantial degree of wiring is required. Thus, it becomes necessary to have a pair of wires for detection with another pair of wires for actuation. This not only adds to installation costs but also creates additional problems in that the smoke and heat evacuation and ventilation system will operate in a substantially different manner to existing fire alarm systems.

Fire detection and alarm systems are known in which detection devices and alarm generating devices are connected across a single pair of wires. This field wiring may pass in and out of each device and an end of line device is connected across the field wiring at the last device. At the controller, resistors form a voltage divider and in a quiescent condition, a steady voltage may be measured. When a detector operates, a switch closes resulting in a comparator at the controller measuring a lower voltage, which in turns causes an alarm to sound.

Sounder circuits are also monitored for short circuit faults. Each sounder includes a blocking diode so as to ensure that current cannot actually flow through them during the quiescent condition. When the alarm is triggered, the current to the sounder circuits is reversed such that current can now flow through the blocking diodes and the alarm sounds. Thus, current flows in a first direction during the detection mode and then flows in the opposite direction during the activation mode. Such a situation is acceptable for alarm devices which, once current is removed, return to their original state; because, an alarm is either sounding or it is not sounding.

The situation with smoke and heat evacuation and ventilation (SHEV) systems is somewhat different. The scenario outlined above for alarm systems would be adequate for the SHEV devices were it only necessary to open them. However, in addition to alarm systems being operational when required, it is also necessary to conduct routine tests such that a test signal is generated to test the ventilation systems which would in turn result in them opening. However, at the completion of the test, it is also necessary for the system to return to its initial state. Thus, a problem exists in that not only is it necessary to open the ventilation devices but, thereafter, it is also necessary to close the ventilation devices. Thus, the ventilation devices not only require power in a first direction, to effect an opening, they also require power to be supplied in the opposite direction so as to ensure that the ventilation devices are closed again, thereby allowing the system to return to a quiescent monitoring state.

### BRIEF SUMMARY OF THE INVENTION

According to an aspect of the present invention, there is provided an interface circuit for a smoke and heat evacuation and ventilation device as set out in claim 1.

According to a second aspect of the present invention there is provided a controller for a plurality of smoke and heat evacuation and ventilation devices as set out in claim 11.

According to a third aspect of the present invention, there is provided a method of controlling a plurality of smoke and heat evacuation and ventilation devices as set out in claim 16.

### BRIEF DESCRIPTION OF THE DRAWINGS

FIG. 1 shows a building of multiple occupancy;

FIG. 2 shows heat evacuation and ventilation devices;

FIG. 3 details a device of the type shown in FIG. 2;

FIG. 4 shows a schematic representation of devices in a building;

FIG. 5 shows a control panel of the type identified in FIG. 4;

FIG. 6 shows an interface circuit for a smoke and heat evacuation and ventilation device;

FIG. 7 shows a graph of field circuit voltage plotted against time; and

FIG. 8 shows an alternative graph of field circuit voltage plotted against time.

### DETAILED DESCRIPTION OF EXAMPLE EMBODIMENTS

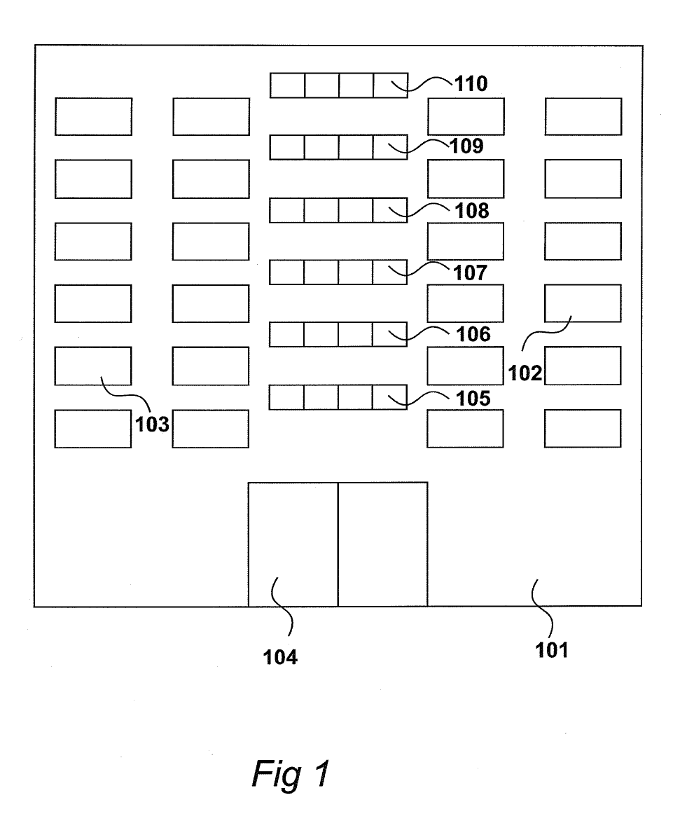

### FIG. 1

A building 101 of multiple occupancy is illustrated in FIG. 1. In this example, building 101 has a total of six floors with a plurality of private dwelling spaces provided on each of these floors. An example of a private dwelling looks out of window 102, with a different dwelling looking out of window 103.

The main front door 104 provides access to shared areas, including central elevators and staircases which provide access to the higher floors.

At each floor of the shared access area, there are provided smoke and heat evacuation and ventilation devices, located substantially just below ceiling level. Thus, for the first floor a group of devices 105 are provided, for the second floor there is a group of devices 106, for the third floor there is a group of devices 107, for the fourth floor there is a group of devices 108, for the fifth floor there is a group of devices 109 and for the sixth floor there is a group of devices 110.

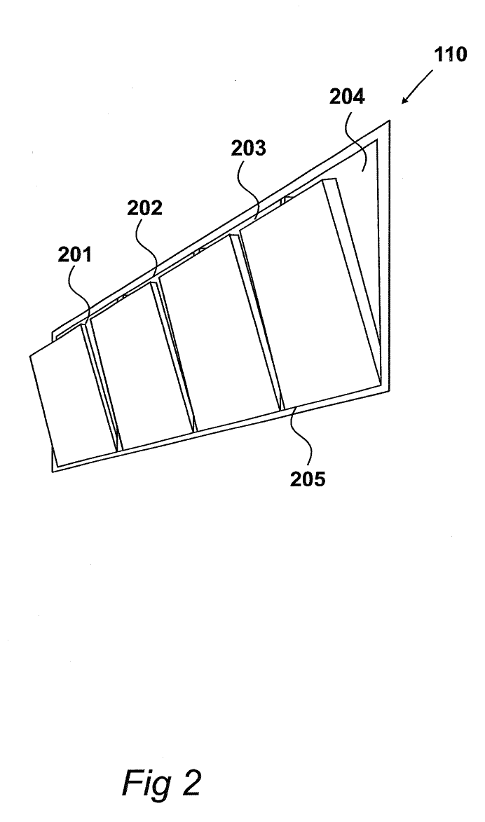

### FIG. 2

The smoke and heat evacuation and ventilation device (SHEV) 110 identified in FIG. 1 is detailed in FIG. 2. In this example, a first window 201 is provided, along with a second window 202, a third window 203 and a fourth window 204. Each of these windows may be opened by the provision of a hinge 205 at their bottom edge. Individual chain activators are provided for each of windows 201 to 204 but in operation, the four windows at each level operate in unison.

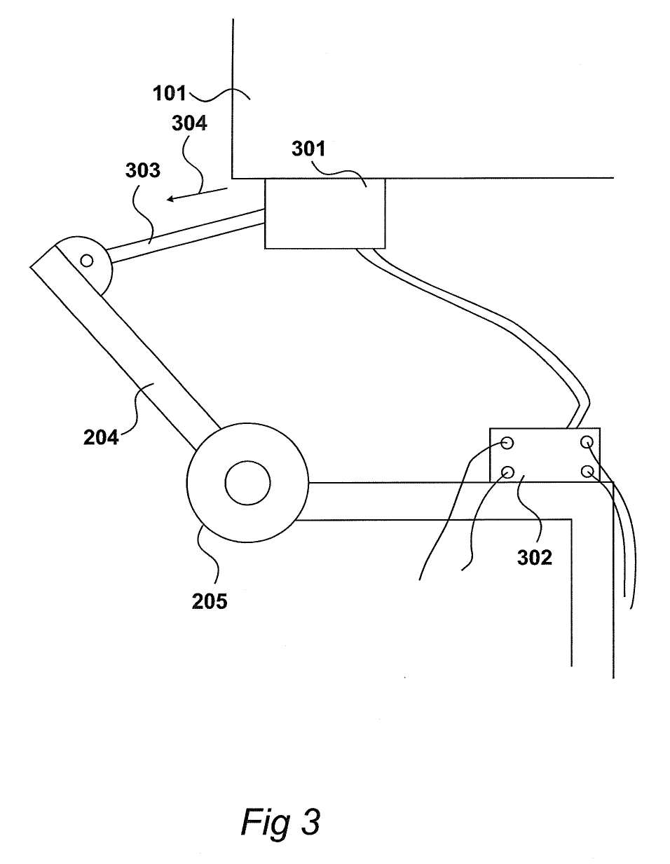

### FIG. 3

Window 204 is shown in greater detail in FIG. 3. A chain actuator 301 is attached to the building 101. The chain actuator 301 receives power from a SHEV controller 302. A voltage is applied to the chain actuator 301 of a first polarity resulting in a chain 303 extending from the actuator 301 in the direction of arrow 304. This releases the window 204 thereby allowing it to open and the weight of the window 204 during the opening process will ensure that chain 303 remains taught.

In order to close the SHEV, the polarity of a drive current supplied to the actuator 301, from the controller 302, is reversed, resulting in chain 303 being retracted back into the actuator 301, thereby closing window 204.

In an embodiment, chain 303 is configured to be of an optimum length to achieve appropriate opening and closing of the window 204. However, in a further embodiment, it is possible for the SHEV controller 302 to include a timer such that the extent to which chain 303 is extended and then retracted may be controlled accurately so as to ensure precise opening and closing without causing damage.

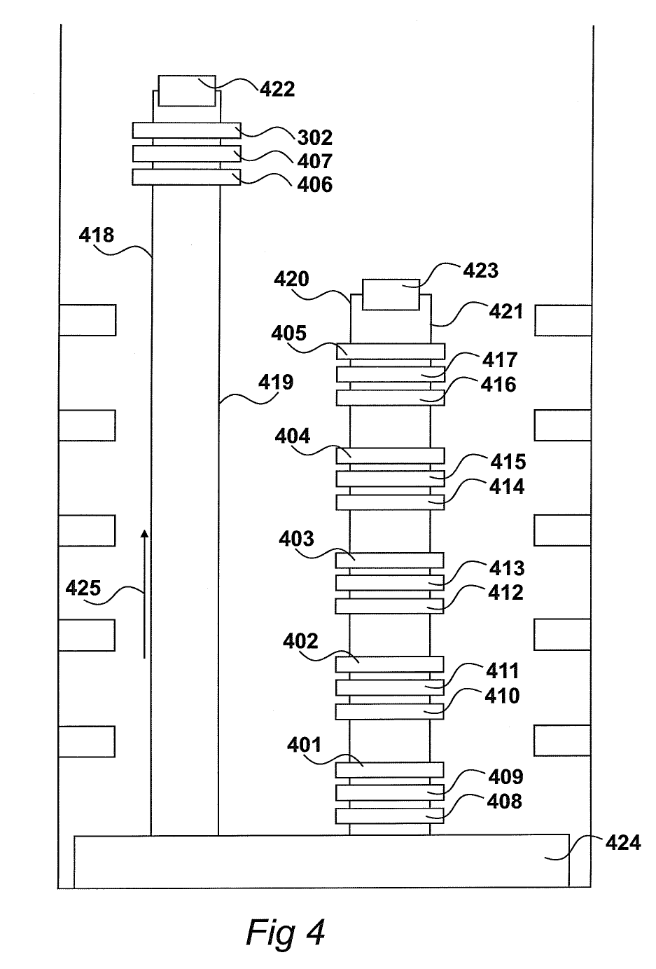

### FIG. 4

A schematic representation of the smoke and heat evacuation and ventilation system is illustrated in FIG. 4. SHEV controller 302 for SHEV 110 is shown, along with similar devices 401 to 405 for SHEVs 105 to 109. In this example, the highest level SHEV 110 defines a first zone with the lower level SHEVs 105 to 109 being connected to a separate second zone. In this way, under certain conditions, it is possible for the top level SHEV 110 to be opened independently of the remaining SHEVs. Thus, in situations of relevantly low levels of smoke and heat, the opening of the upper-most SHEV 110 may be sufficient. However, if a greater level of evacuation is required, the second zone may be activated thereby opening the remaining SHEVs 105 to 109.

In addition to the SHEV controller, each floor also includes a fire alarm and a fire detector. Thus, on the uppermost floor there is provided a detector 406 and an alarm 407. Similarly, on the ground floor there is provided a detector 408 and an alarm 409. On the remaining floors, detectors 410, 412, 414 and 416 are provided with alarms 411, 413, 415 and 417 respectively.

The detectors, alarms and SHEV controllers may be referred to as ancillary devices and as such are connected across field wires 418 and 419 for the first zone, or across field wires 420 and 421 for the second zone. At their ends, the field wires 418, 419 for the first zone are terminated by a first end of line device 422 and field wires 420, 421 of the second zone are terminated by a second end of line device 423.

The field wires communicate with a control circuit 424 which, in an embodiment, is housed behind a control panel located at an accessible position to facilitate testing and resetting thereof. In this example, control panel 424 is capable of supporting two zones as illustrated in FIG. 4. However, it should be appreciated that alternative configurations are possible, depending on the particular application required.

The arrangement shown in FIG. 4 provides for the controlling of a plurality of smoke and heat evacuation and ventilation devices connected to field wiring that also includes fire detection devices and alarms. In an embodiment, a constant limited current is supplied in a first direction, indicated by arrow 425 for fire detection. A non limited voltage is applied to supply alarm current in a second direction for sounding alarms and opening the SHEVs. Furthermore, a non limited voltage is also applied to supply reset current in the first direction for closing the SHEVs.

For detection purposes, current limiting is provided to facilitate accurate voltage measurement for the detection of device activation. During alarm activation, the current is reversed and the current limiting devices are taken out of circuit. Similarly, it is possible for the current to be returned to its primary direction (as used in detection) but again with the current limiting devices taken out of circuit so as to facilitate SHEV closure and thereby establishing a reset condition.

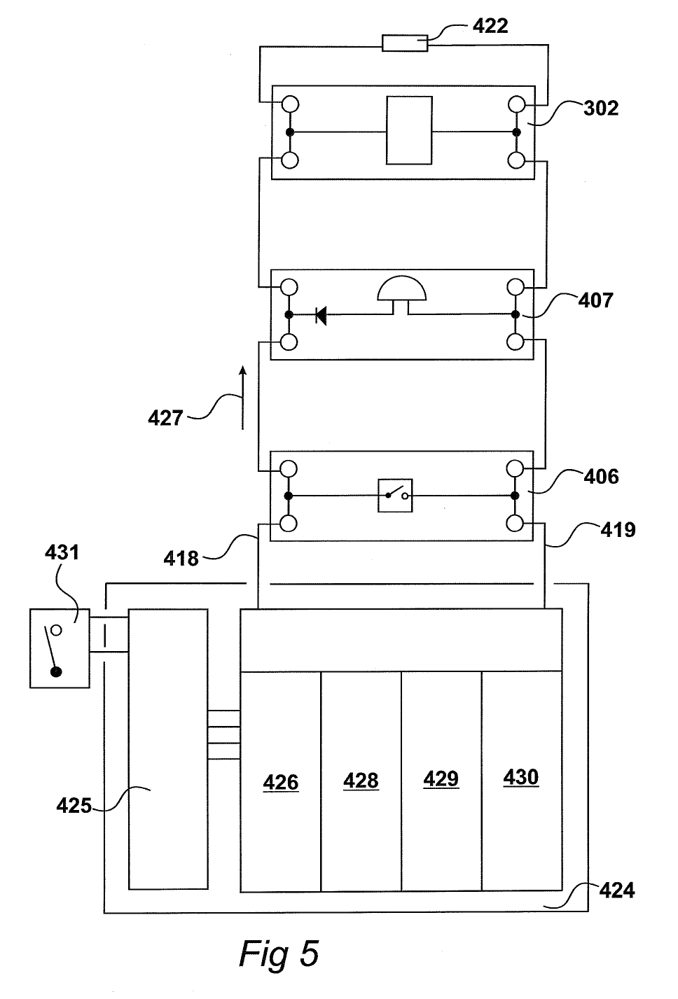

### FIG. 5

Control panel 424 is shown in FIG. 5. Field wires 418 and 419 extend from the control panel to the ancillary equipment 406, 407 and 302. These field wires carry power and communications to the ancillary equipment and must allow the control panel to respond when an alert condition (such as a fire) has been detected. Furthermore, if a detector is removed a signal is again sent back to the control panel to indicate a fault condition and the control panel is also responsive to the manual control points.

In order to active the SHEVs it is necessary to supply sufficient current. Thus, in an example, it may be necessary to pass three to ten amps down two wires that are normally limited to, say, 100 mA in the forward direction. Systems of this type may be configured to provide between one and two amps in the reverse direction in order to operate the alarms.

In an embodiment, the SHEVs open when there is an alarm condition and then close in response to a reset condition. However, in an embodiment, compatibility is maintained with fire detection components.

In an embodiment, the current limit is bypassed for a set duration, during which time twenty-four volts (24 v) are applied to power the SHEVs. However, upon reset, the fire detection components are returned back to their normal operation. Thus, the current limit is bypassed so as to supply enough power to close the SHEVs. However after a period of time, the current limit is reintroduced thereby limiting the current to typically 30 mA.

The control circuit 424 includes a micro controller 425 configured to control the timing of SHEV operation. Thus, typically, SHEVs may be powered for between twenty to thirty seconds, during which time monitoring of the fire detectors is not available. However, after this timeout period, the current limit is brought back into play such that there is a voltage drop across the end of the line. When a detector is triggered, it pulls the voltage down to typically twelve volts and this can be detected at the control panel.

For the alarm condition, the polarity is reversed and in an embodiment, twenty four volts (of opposite polarity) is made available for a period of thirty seconds so as to open the SHEVs. In an embodiment, the alarms will sound due to the current being reversed. In an embodiment, the end of line device 422 includes a diode thereby placing it out of circuit during this reverse mode of operation.

The controller may be for a plurality of smoke and heat evacuation and ventilation devices connected to field wiring but the system also includes fire detection devices and alarms. A first driving circuit 426 provides a constant limited current in a first direction 427 through the field wiring. The first driving circuit also includes detection capability for detecting alarm conditions in response to voltage changes when the constant limited current is applied.

A second driving circuit 428 is configured to supply an opposite polarity voltage to the field wiring in order to activate the alarms and to open the SHEV devices. Furthermore, a third driving circuit 429 is configured to apply a non-limited voltage to the field wiring to provide a current in the first direction in order to close the SHEV devices.

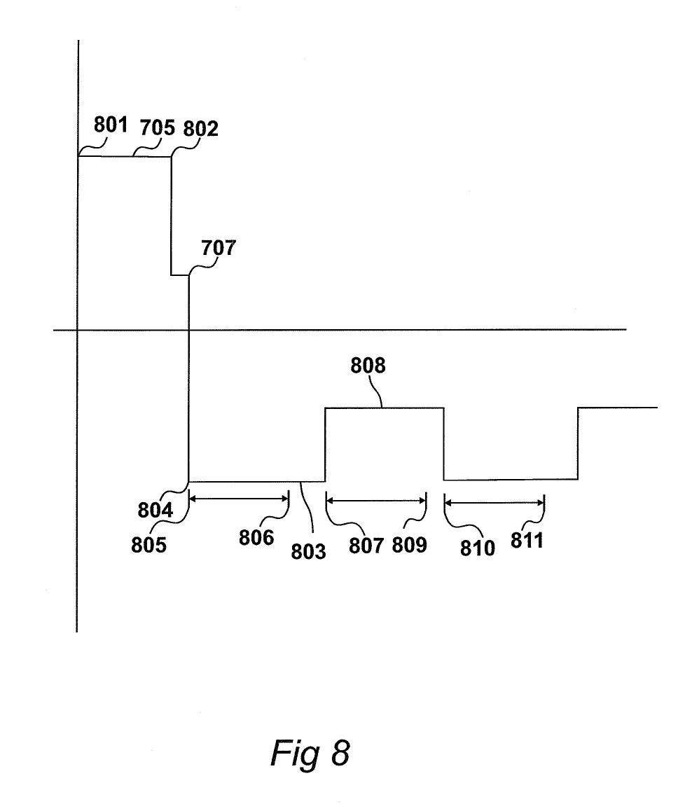

In an embodiment, the controller 424 also includes a fourth driving circuit 430 for modifying the operation of the second driving circuit 428 to indicate that SHEV devices are to close during an alarm condition, in response to the operation of a switch 431. In an embodiment, the fourth driving circuit 430 introduces a step change to the opposite polarity voltage, as detailed with reference to FIG. 8. The fourth driving circuit is activated in response to manual control by the operation of switch 431. Thus, for example, this may occur in response to a manual activation made by a fire officer. Thus, in an embodiment, it is possible for the SHEV devices to be manually closed and then reopened as required during an alarm condition.

In the embodiment of FIG. 5, the controller 424 is shown operating just the first zone. In an embodiment, the controller controls two zones and it should be appreciated that many zones could be controlled within a building in this way. In an embodiment, the first driving circuit 426 provides a constant current by the provision of a base emitter drop across a resistor. In an embodiment, voltage modulation is provided in order to adjust the voltage on the line to the SHEV controller.

Many approaches to embodying the circuits of FIG. 5 would be well known to those skilled in the art but in a specific implementation, the constant current circuit is bypassed by a P-channel FET; thus bypassing the voltage control and the short circuit limit. In an implementation, this goes into a bridge configuration, which allows the polarity to be reversed. The P-channel FET is turned on in order to feed the high current to the SHEV device, and the control for the bridge comes from the micro controller 425; with the bridge bypassing the current limiter.

After, say, sixty seconds, the micro controller may turn off the bypass transistor and disable the bridge. Thus, the current limiting operation resumes and the voltages are monitored by an analog to digital converter which provides feed-back to the micro controller 425.

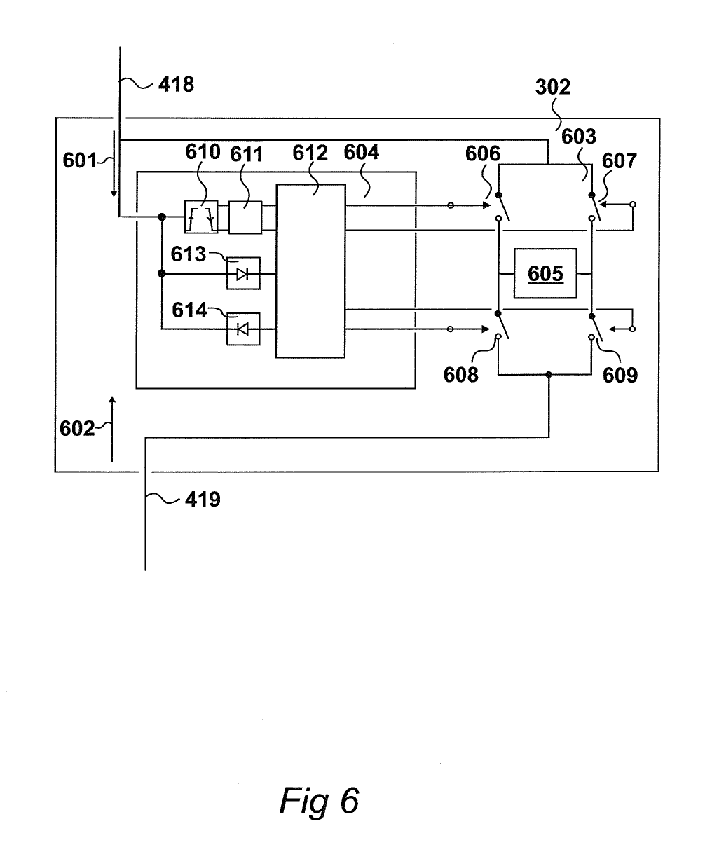

### FIG. 6

An interface circuit for a smoke and heat evacuation and ventilation device connectable to field wiring that is compatible with a fire detection and alarm system is illustrated in FIG. 6. The SHEV controller 302 is connected to field wiring 418, 419. Field current passes through the field wiring in a first direction, indicated by arrow 601, or in a second direction, i.e. the opposite direction, in the direction of arrow 602. Thus, in an embodiment, a current may flow in the direction of arrow 601 during the detection mode and a current may flow in the direction of arrow 602 in the alarm sounding mode.

In the interface device, a switching circuit 603 is provided for supplying an opening current or a closing current to the SHEV device from the field wiring circuit. Furthermore, a control circuit 604 controls the switching circuit 603 in response to control conditions detected in the field current.

An actuator 605 receives current from switching circuit 603. In an embodiment, the actuator 605 controls the opening and closing of windows, of the type illustrated in FIG. 2. Thus, the actuator is driven in a first direction for opening the window and is driven in a second opposite direction when closing the window.

In a quiescent monitoring mode, that is to say when a current is flowing in the direction of arrow 601, this current is limited and, in some embodiments, may also be intermittent in order to conserve power. In an embodiment, the current limiting device is bypassed when SHEV closing current is required.

As illustrated in FIG. 6, in this embodiment, the switching circuit 603 is configured as a bridge, having four switching devices 606, 607, 608 and 609. When all of the switches are open, as illustrated in FIG. 6, no power is supplied to the SHEV controller 605. To operate the actuator 605, switch 606 and switch 609 may be closed. Alternatively, with switches 606 and 609 open, switches 607 and 608 may be closed. Thus, by appropriate operation of the switches of the bridge circuit 603, it is possible to supply a voltage of either polarity across actuator 605 irrespective of the direction of incoming current. However, in order to effect the appropriate switching configuration, the control circuit 604 may monitor conditions detected upon the field current.

In the embodiment of FIG. 6, the control circuit 604 includes an edge detection circuit 610, configured to produce an output signal to a timer 611 upon detecting an edge or sudden change in the field current. Thus, in this way, it is possible for the polarity of the field current to remain unchanged while conveying information through the field current loop by a sudden change in the voltage applied to the field wire loop. The timer 611 will produce an output of variable duration to switching logic 612 after receiving an input from the edge detection circuit 610. The timer 611 is adjustable, so as to provide a mechanism for ensuring that the actuator 605 receives drive current for an optimised period of time. Thus, in this way, windows, such as window 204, will be closed shut; without causing damage due to the actuator receiving drive current for too long. In an embodiment, the timer 611 may provide a drive signal for a period that is variable up to a total 30 seconds.

In addition to edge detection, a first rectifier 613 provides a signal to switching logic 612 when current is flowing in the direction of arrow 601. Similarly, a second rectifier 614 provides an input signal to switching logic 612 when current flows in the direction of arrow 612. Consequently, operations performed within the switching logic 612, and subsequently the operation of switches 606 to 609, will be influenced by the direction of current flow. Thus, with this combination of detectors, the control circuit 604 responds to sudden changes in applied voltage and voltage polarity.

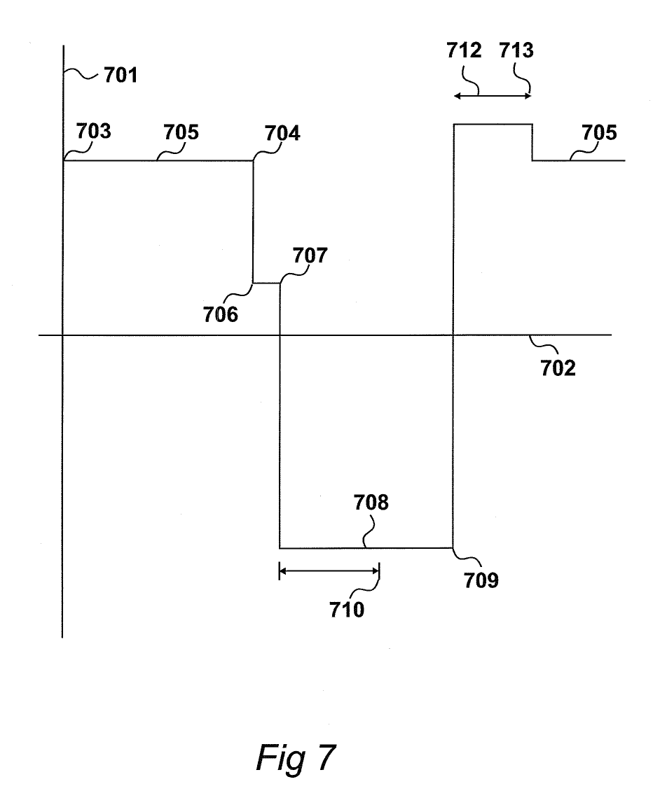

The switching logic 612 is configured to operate switches 606 to 609 in response to inputs from circuit 611, 613 and 614. The operation of this logic will be described with reference to FIGS. 7 and 8 and its specific implementation would be clear to those skilled in the art.

### FIG. 7

A graph shown in FIG. 7 shows field circuit voltage 701 plotted against time 702. From time 703 to time 704, the system is in its quiescent state and is monitoring the activation of fire detectors. In an embodiment, a voltage 705 of typically 17 volts is applied resulting in the flow of a limited current of 30 milliamps.

At time 704, for the purposes of this example, an alarm condition is detected resulting in the voltage drop across the loop being reduced to 706, typically a drop of 12 volts down to 5 volts. There is a short reaction time from time 704 to time 707, whereafter the control panel recognises this voltage drop as an alarm condition and therefore takes action in order to sound the alarms. This action involves reversing the flow of current (from direction 601 to direction 602) while taking current limiting devices out of circuit. Thus, at time 707 the voltage across the loop is changed from voltage 706 (plus 5 volts) to voltage 708, typically minus 24 volts. This alarm condition, for the purposes of this example, is sustained from a time 707 to a time 709.

At time 707, the step change on the field loop (a falling edge) is detected by edge detection circuit 610. Furthermore, polarity detector 614 will subsequently identify the flow of current as being in the direction of arrow 602. This condition is recognised by the switching logic 612 such that, in this example, switch 609 and switch 606 are closed resulting in a voltage being applied across actuator 605 in order to open the SHEV device. Under the control of timer 611, this drive power to the SHEV is maintained until time 710, whereafter, a timeout occurs and no further power is conveyed to the SHEV controller. Thus, at time 710 the SHEV has been fully opened and the SHEV remains open until time 709.

At time 709 a reset condition occurs to the effect that the system may be put back to its monitoring condition. The reset condition is initiated at time 709 and in a conventional fire detection system, the system would return to a monitoring state at time 709. However, in the present embodiment, it is necessary to close the SHEV devices before quiescent monitoring may be re-adopted.

In order to close the SHEV devices, the current limiting circuitry at the control panel remains out of circuit and a voltage 712 of typically 20 volts is applied until time 713. The edge at time 709 is detected by edge detection circuit 710. After time 709, current flows in the direction of arrow 601, therefore a positive indication is provided by detector 613. The polarity has reversed therefore the closing of switches 606 and 609 results in the actuator operating in the reverse direction, thereby closing the windows. The closing operation may take place for the full duration from time 711 to time 713. However, the timer 611 may reduce this period such that the window closes without causing damage. At time 713, the current limiting devices are brought back into circuit and the monitoring operation is resumed, with the field loop voltage back to level 705.

### FIG. 8

In an embodiment, it is also possible for the SHEV devices to be closed while in the alarm condition. Such an operation is required in order to allow fire officers to manually control the SHEVs while maintaining the alarm condition. As illustrated in FIG. 8, it is assumed that the system is in its quiescent state with a voltage 705 from time 801 to time 802. At time 802 an alarm condition is detected resulting in the voltage dropping to level 707, followed by the control circuit reversing the current to produce a voltage of value 803 (minus 24 volts) at time 804. Thus, as previously described, a SHEV activation period exists from time 805 to time 806.

In the example shown in FIG. 8, it is assumed that the alarm condition is sustained throughout. However, at time 807 a manual selection is made at the control panel (by switch 431) in order to close the SHEV devices. This results in the alarm voltage being modified from level 804 (typically minus 24 volt) to a modified level 808 (of typically 12 volt). At the SHEV controllers, the step change at time 807 is detected by edge detectors 610, again as a positive rising edge. In response to this, an activation signal is supplied to timer 611 which in turn provides an appropriate indication to logic circuit 612. In this way, it is possible for the switching circuit to be configured so as to cause the SHEV to close, with an activating signal being available from time 807 to time 808.

For the purposes of this example, it is assumed that the SHEV devices are opened again at time 809. This is achieved by returning the loop voltage to level 803 (minus 24 volt), resulting in falling edge 810 being detected at edge detector 610. As a result of this, an activating signal is again generated at time 809 which is maintained until time 810, resulting in the SHEV devices opening again.

Thus, with the device open, the generation of a rising edge with a current of negative polarity, results in the SHEV closing. In this way, it is possible to close the device for fire officer access even when the system is in an alarm condition. The alarm is preserved because the SHEV controller is looking for the edge.

In an embodiment, a 250 millisecond delay is introduced and by using the edge detection and polarity sensing it is possible to determine the state required for the SHEV device. This is used in combination with timer 611 so as to control the duration of activation up to a maximum of 60 seconds, in an embodiment.

1-24. (canceled)

25. An interface circuit for a smoke and heat evacuation and ventilation (SHEV) device connectable to field wiring compatible with a fire detection and alarm system, in which a field current passes through said field wiring in a first direction or in a second direction (opposite to said first direction), said interface circuit comprising:
a switching circuit for supplying an opening current or a closing current to said SHEV device from said field wiring current; and
a control circuit for controlling said switching circuit in response to control conditions detected in said field current.

26. The interface circuit of claim 25, wherein said SHEV device includes an opening window and an actuator for opening said window when driven in a first direction and closing said window when driven in a second direction.

27. The interface circuit of claim 25, wherein a limited field current passes through said field wiring via a current limiting device in said first direction during a quiescent monitoring period.

28. The interface circuit of claim 26, wherein a limited field current passes through said field wiring via a current limiting device in said first direction during a quiescent monitoring period.

29. The interface circuit of claim 27, wherein said current limiting device is bypassed when a SHEV closing current is required.

30. The interface circuit of claim 28, wherein said current limiting device is bypassed when a SHEV closing current is required.

31. The interface circuit of claim 27, wherein said limited field current is supplied periodically to reduce power consumption.

32. The interface circuit of claim 25, wherein said switching circuit is configured as a bridge having four switching devices.

33. The interface circuit of claim 25, wherein said control conditions include a voltage and/or current step change and said control circuit includes and edge detection device.

34. The interface circuit according to claim 33, wherein said control circuit includes a polarity detection device for detecting whether said field current is flowing in said first direction or said second direction.

35. The interface circuit of claim 34, wherein said control circuit includes combinational logic for controlling said switching circuit in response to inputs from said edge detection device.

36. The interface circuit of claim 25, including a timing circuit for controlling activation duration during which an opening current or a closing current is supplied to said SHEV device.

37. A controller for a plurality of smoke and heat evacuation and ventilation (SHEV) devices connected to field wiring that also includes fire detection devices and alarms, comprising:
first driving means for driving a constant limited current in a first direction through said field wiring;
detection means for detecting alarm conditions in response to voltage changes when applying said constant limited current;
second driving means for supplying an opposite polarity voltage to said field wiring to activate said alarms and to open said SHEV devices; and
third driving means for applying a non-limited voltage to said field wiring to provide current in said first direction to close said SHEV devices.

38. The controller of claim 37, further comprising fourth driving means for modifying the operation of said second driving means to indicate that SHEVs are to close during an alarm condition.

39. The controller of claim 38, wherein said fourth driving means introduces a step change to said opposite polarity voltage.

40. The controller of claim 38, wherein said fourth driving means is activated in response to manual control.

41. The controller of claim 39, wherein said fourth driving means is activated in response to manual control.

42. The controller of claim 37, comprising driving means for a plurality of field wiring zones.

43. A method of controlling a plurality of smoke and heat evacuation and ventilation (SHEV) devices connected to field wiring that also includes fire detection devices and alarms, comprising the steps of:
supplying a constant limited current in a first direction for fire detection;
applying a non-limited voltage to supply alarm current in a second direct for sounding alarms and opening said SHEVs; and
applying a non-limited voltage to supply reset current in said first direction for closing said SHEVs.

44. The method of claim 43, wherein the SHEVs are manually closable in response to a manual intervention when said alarm current is flowing in said second direction.

45. The method of claim 44, wherein said manual intervention generates a voltage and/or current step change and each SHEV is responsive to said step change.

46. The method of claim 44, wherein said SHEVs have a controller and an actuator, and each said controller includes an edge detection circuit and a bridged switching circuit, wherein said bridged switching circuit is configured to switch the polarity of current supplied to an actuator.

47. The method of claim 46, wherein each SHEV controller includes polarity detection devices for detecting the polarity of a voltage received from the field wiring.

48. The method of claim 46, wherein edge detectors detect said step change and in combination with outputs from said polarity detection devices, control said bridge switching circuit.

49. The method of claim 43, further comprising the step of restricting an activation current and a reset current for a predetermined time interval.
